(19) United States
(12) Patent Application Publication
(10) Pub. No.: US 2025/0245728 A1
(43) Pub. Date: Jul. 31, 2025

(54) SYSTEM AND METHOD FOR GENERATING COHESIVE PRODUCT RECOMMENDATIONS

(71) Applicant: Walmart Apollo, LLC, Bentonville, AR (US)

(72) Inventors: Morteza Farrokhsiar, San Francisco, CA (US); Najmeh Forouzandehmehr, Sunnyvale, CA (US); Ramin Giahi, Rego Park, NY (US); Evren Korpeoglu, San Jose, CA (US); Kannan Achan, Saratoga, CA (US)

(21) Appl. No.: 19/026,201

(22) Filed: Jan. 16, 2025

Related U.S. Application Data
(60) Provisional application No. 63/627,286, filed on Jan. 31, 2024.

(51) Int. Cl. G06Q 30/0601

(52) U.S. Cl. CPC G06Q 30/0631; G06Q 30/0603

(57) ABSTRACT

System and methods for generating cohesive product recommendations are disclosed. In some embodiments, a disclosed method includes: storing, in a database, historical customer data associated with a customer, receiving an indication of a customer's selection of a first product, parsing and extracting first product description data from catalog description data, generating summary data of the first product description data, the summary data being a subset of the first product description data, and generating a plurality of recommended products based on the summary data, the historical customer data, and at least one business rule.

### TECHNICAL FIELD

This application claims benefit to U.S. Provisional Application Ser. No. 63/627,286, entitled “SYSTEM AND METHOD FOR GENERATING COHESIVE PRODUCT RECOMMENDATIONS,” filed on Jan. 31, 2024, the disclosure of which is incorporated herein by reference in its entirety.

### TECHNICAL FIELD

This application relates generally to managing retail products and, more particularly, to systems and methods for generating cohesive product recommendations.

### BACKGROUND

Retailers on consistently providing recommendations of products to customers using an e-commerce platform. For example, customers looking for specific products can be provided with other products for purchase. Retailers present recommended products to increase the amount that a customer purchases. This results in increase sales of products, overall gross merchandise value (GMV) and overall revenue for the retailer. However, retailers face difficulties determining which products to offer to the customer that will result in the customer purchasing an additional product.

Current methods of recommending products to a customer include looking through a database or catalog of products and identifying similar products. For example, a customer searching for a shirt may be provided other similar shirts as recommended products for purchase. However, the customer may require pants or accessories for matching with the shirt. Current methods are not specific to the customer nor do they provide any cohesive look to the customer.

### SUMMARY

The embodiments described herein are directed to systems and methods for generating cohesive product recommendations.

In various embodiments, a system including a database storing historical customer data associated with a customer, a computing device comprising at least one processor in communication with the database, the computing device being configured to receive an indication of a customer's selection of a first product, parse and extract first product description data from catalog description data, generate summary data of the first product description data, the summary data being a subset of the first product description data, generate a plurality of recommended products based on the summary data, the historical customer data, and at least one business rule.

In some embodiments, the computing device is further configured to generate recommended product description data associated with the plurality of recommended products, query a catalog based on the recommended product description data, and based on the query, generate the plurality of recommended products.

In some embodiments, the computing device is further configured to group the plurality of recommended products by product type, apply one or more weights to each of the plurality of recommended products within each product type, the one or more weights being applied based on the historical customer data, and prioritize, within each product type, the plurality of recommended products based on the applied one or more weights.

In some embodiments, the computing device is further configured to cause a user interface to display a visual representation of the plurality of recommended products, the visual representation of the plurality of recommend products being displayed proximate a visual representation of the first product.

In some embodiments, the summary data is generated using a generative artificial intelligence algorithm. The summary data is generated using a large language model.

In some embodiments, each of the plurality of recommended products is visually cohesive with the first product.

In some embodiments, the historical customer data includes interaction data associated with the customer's interactions with one or more retail products provided on an e-commerce platform.

In some embodiments, the plurality of recommended products are each from a different product type. The first product is a different product type than each of the plurality of recommended products.

In various embodiments, a computer-implemented method is disclosed. The computer-implemented method includes storing, in a database, historical customer data associated with a customer, receiving an indication of a customer's selection of a first product, parsing and extracting first product description data from catalog description data, generating summary data of the first product description data, the summary data being a subset of the first product description data, and generating a plurality of recommended products based on the summary data, the historical customer data, and at least one business rule.

In some embodiments, the method further includes generating recommended product description data associated with the plurality of recommended products, querying a catalog based on the recommended product description data, and based on the query, generating the plurality of recommended products.

In some embodiments, the method further includes grouping the plurality of recommended products by product type, applying one or more weights to each of the plurality of recommended products within each product type, the one or more weights being applied based on the historical customer data, and prioritizing, within each product type, the plurality of recommended products based on the applied one or more weights.

In some embodiments, the method further includes causing a user interface to display a visual representation of the plurality of recommended products, the visual representation of the plurality of recommend products being displayed proximate a visual representation of the first product.

In some embodiments, the summary data is generated using a generative artificial intelligence algorithm. The summary data is generated using a large language model.

In some embodiments, each of the plurality of recommended products is visually cohesive with the first product.

In some embodiments, the historical customer data includes interaction data associated with the customer's interactions with one or more retail products provided on an e-commerce platform.

In some embodiments, the first product is a different product type than each of the plurality of recommended products.

In various embodiments, a non-transitory computer readable medium having instructions stored thereon is disclosed. The instructions, when executed by at least one processor, cause at least one device to perform operations including: storing, in a database, historical customer data associated with a customer, receiving an indication of a customer's selection of a first product, parsing and extracting first product description data from catalog description data, generating summary data of the first product description data, the summary data being a subset of the first product description data, and generating a plurality of recommended products based on the summary data, the historical customer data, and at least one business rule.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to generate cohesive product recommendations, in accordance with some embodiments of the present teaching.

FIG. 2 is a block diagram of a recommendation engine, in accordance with some embodiments of the present teaching.

FIG. 3 is a flow diagram of a system for generating cohesive product recommendations, in accordance with some embodiments of the present teaching.

FIG. 4 is a flow diagram of a recommendation engine of the system for generating cohesive product recommendations of FIG. 3, in accordance with some embodiments of the present teaching.

FIG. 5 is a flow diagram of a recommendation engine of the system for generating cohesive product recommendations of FIG. 3, in accordance with some embodiments of the present teaching.

FIG. 6 is a block diagram illustrating a user interface providing cohesive product recommendations, in accordance with some embodiments of the present teaching.

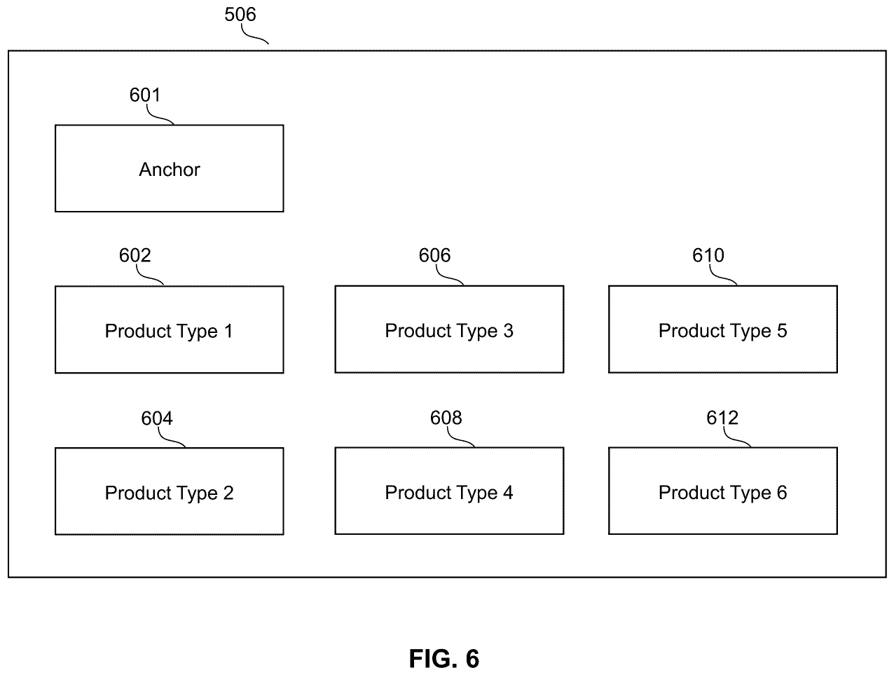

FIG. 7 is a flowchart illustrating an exemplary method for generating cohesive product recommendations, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for generating cohesive product recommendations. In some embodiments, the systems and methods utilize models (e.g., machine learning models) to cohesive product recommendations. For example, the system and methods may utilize a generative artificial intelligence algorithm (e.g., a large language model (LLM)) or other type of model/algorithm configured to perform natural language processing (NLP) tasks. The systems and methods provided herein may be used to generate cohesive product recommendations. For example, the systems and method provided herein may generate recommendations for one or more products (e.g., items) based off an initial product. The recommendations may include one or more products that are related to the initial product (e.g., that are cohesive), but are a different product type. The systems and methods may then provide a prioritization of one or more recommend products.

One goal of the present teaching is to generate cohesive product recommendations of different product types to the customer. In some embodiments, a disclosed system utilizes one or more models to generate and prioritize the recommendations of different product types. The system can prioritize a plurality of recommended products of different product types and display these for the customer via a user interface.

In some embodiments, the system includes a user interface to provide the customer the one or more recommended products. The user interface may also provide to the user a prioritization of recommended products. The recommend products may be a plurality of products each being a different product type. For example, the recommended products may include pants, shoes, watch, and outerwear - each being from a different product type. In some embodiments, the system automatically generates recommended products of different product types and provides these to the customer upon selection of an initial item (e.g., an anchor item).

In some embodiments, the system includes a user interface to provide the product recommendations to the customer. The user interface may also provide a plurality of recommended products of different product types in a specific arrangement to the customer. In some embodiments, the system automatically generates the plurality of products in the specific arrangement for display to the user via the user interface. The user may interact with the user interface to select one or more of the plurality of recommended products for purchase.

Furthermore, in the following, various embodiments are described with respect to methods and systems for generating cohesive product recommendations. In some embodiments, a disclosed method includes: storing, in a database, historical customer data associated with a customer, receiving an indication of a customer's selection of a first product, parsing and extracting first product description data from catalog description data, generating summary data of the first product description data, the summary data being a subset of the first product description data, and generating a plurality of recommended products based on the summary data, the historical customer data, and at least one business rule.

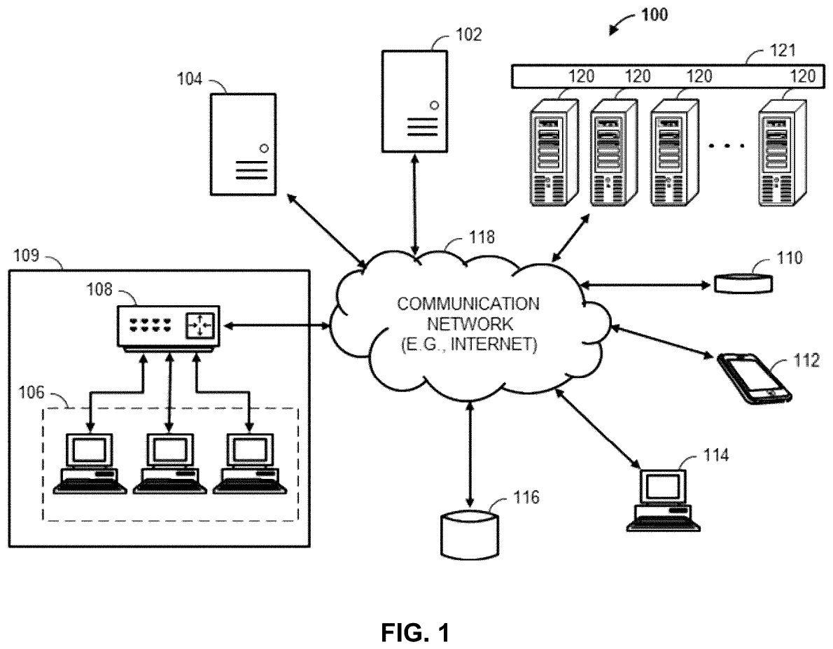

Turning to the drawings, FIG. 1 is a network environment 100 configured to generate cohesive product recommendations, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, recommendation engine 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The recommendation engine 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the recommendation engine 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the recommendation engine 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the recommendation engine 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the recommendation engine 102 over the communication network 118. The workstation(s) 106 may send data to, and receive data from, the recommendation engine 102. For example, the workstation(s) 106 may transmit data identifying items purchased by a customer at the store 109 to the recommendation engine 102.

Although FIG. 1 illustrates three user computing devices 110, 112, 114, the network environment 100 can include any number of user computing devices 110, 112, 114. Similarly, the network environment 100 can include any number of the recommendation engine 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view a user interface for viewing and interacting with an anchor product (e.g., anchor item) and cohesive product recommendations generated by recommendation engine 102. The website may capture these activities as user session data, and transmit the user session data to the recommendation engine 102 over the communication network 118. The website, via the user interface, may also allow the user to view and interact with an anchor product and one or more products recommended to the user by the recommendation engine 102. In some examples, the web server 104 transmits user data to the recommendation engine 102. The user data may include data associated with the user's interaction with the website via the user interface.

In some examples, a user (e.g., a customer) may use one of the user computing devices 110, 112, 114 to view and interact act with one or more products recommended by the recommendation engine 102. The user may use a user interface to view and purchase products via web server 104. The user may, via the web browser or the user interface, view and interact with one or more products. The website may capture at least some of these activities as user data. The web server 104 may transmit the user data to the recommendation engine 102 over the communication network 118, and/or store the user data to the database 116.

In some embodiments, the web server 104 transmits a recommendation request to the recommendation engine 102, e.g. based on a customer's interaction. For example, the recommendation request may be sent based on a user adding one or more items (e.g., anchor product) to their cart on an e-commerce platform. The recommendation request may be sent standalone or together with other related data of the website. In some examples, the recommendation request may carry or indicate user data. In some examples, the recommendation engine 102 may execute one or more models (e.g., algorithms), such as a mathematical models, machine learning model, deep learning model, statistical model, etc., to generate one or more recommended products or product types.

The recommendation engine 102 is further operable to communicate with the database 116 over the communication network 118. For example, the recommendation engine 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the recommendation engine 102, in some examples, the database 116 can be a local storage device, such as a hard drive, a non-volatile memory, or a USB stick. The recommendation engine 102 may store historical data, business metrics, user data, or data associated with one or more products received from the web server 104 in the database 116. The recommendation engine 102 may receive customer data (e.g., customer historical data). The recommendation engine 102 may also receive from the web server 104 user session data identifying events associated with browsing sessions, and may store the user session data in the database 116. Database 116 may be coupled to a computing device. For example, database 116 may be coupled to one or more user computing devices 110, 112, 114 via communication network 118.

In some embodiments, the web server 104 transmits a model training request to the recommendation engine 102. Upon the model training request, the recommendation engine 102 may retrieve, e.g. from the database 116, historical data associated browsing history of a customer. The recommendation engine 102 may train one or more models using the historical data of the customer. The one or more models may be trained to generate cohesive product recommendations and prioritize the product recommendations based on the specific customer. The one or more models may be trained to generate cohesive product recommendations to the customer based on an initial product interacted with by the customer (e.g., anchor item). The one or more models may also be configured to prioritize a plurality of recommended products within each product type. For example, the one or more models may be configured to generate a plurality of recommended products in various product types and may prioritize one or more recommended products within each product type.

In some embodiments, the one or more models are configured to parse and extract necessary description data (e.g., text) associated with the anchor item and generate a concise description of the anchor time. The one or more models may further be configured to generate a plurality of product recommendations that are cohesive (e.g., related) to the anchor item based on the concise description.

In some embodiments, the outputs from the model may be used to refine and train the model. For example, one or more models may be trained using historical data (e.g., historical transaction data of the customer) and may generate a plurality of recommended products in various product types for the customer. Recommendation engine 102 may receive purchase data associated with whether the customer purchased the one or more of the recommended products (e.g., purchased products). The purchase data, including the purchased products, may be inputted into the one or more models such that the one or more models compares the purchased products to the recommended products to generate a comparison value. The greater the comparison value the greater the deviation the purchased product is from the recommended products. In other words, the greater the comparison value, the less accurate the one or more models is. In some embodiments, the comparison value may be inputted into the one or more models to refine the one or more models to make the one or more models more accurate.

The models, when executed by the recommendation engine 102, allow the recommendation engine 102 to generate a plurality of recommended products in various product types for the customer. In some examples, the recommendation engine 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the recommendation engine 102 may generate a plurality of recommended products in various product types for the customer and prioritize the plurality of recommend products based on the customer's historical transaction data. The recommendation engine 102 may provide a user interface to allow a user to interact with the recommended products. For example, the user interface may allow a user to view and interact with the recommend products to purchase one or more of the recommended products.

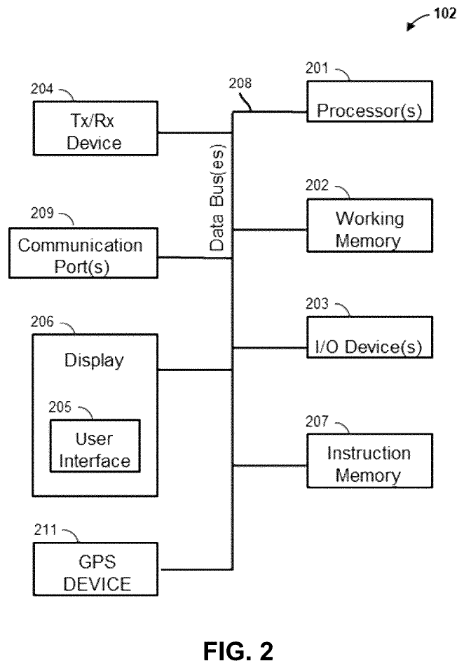

FIG. 2 illustrates a block diagram of a recommendation engine, e.g. the recommendation engine 102 of FIG. 1, in accordance with some embodiments of the present teaching. In some embodiments, each of the recommendation engine 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the recommendation engine 102 can be combined, omitted, and/or replicated. In addition, it will be appreciated that additional elements other than those illustrated in FIG. 2 can be added to the recommendation engine 102.

As shown in FIG. 2, the recommendation engine 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the recommendation engine 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the recommendation engine 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the recommendation engine 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the recommendation engine 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the recommendation engine 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the recommendation engine 102 and/or the web server 104. For example, the user interface 205 can be a user interface for an application of a network environment operator that allows a customer to view and interact with the plurality of recommended products generated by the recommendation engine 102. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the recommendation engine 102 may determine a local geographical area (e.g., town, city, state, etc.) of its position.

In some embodiments, the recommendation engine 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the recommendation engine 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data may include historical data of customers. Further, the training data includes historic sales data (e.g., of the recommended products), typically for one or more years, in association with historic inventory information, historic marketing information, and other such information. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems is configured to receive feedback information at least through the graphical user interface corresponding to actions by the different recipients interfacing with the respective graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained models to provide more accurate recommended products and prioritization of the recommended products to the customer. This allows the models to be refined per customer to provide recommended products that the customer has a high likelihood of purchasing.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information through the graphical user interface corresponding to actions by the recipient interfacing with the graphical user interface.

The above and below description includes descriptions of embodiments implementing and/or utilizing trained machine learning models and/or neural networks. In some embodiments, the neural network, machine learning models and/or machine learning algorithms may include, but are not limited to, Large Language Models (LLM), Heuristics, Univariate based techniques, Multivariate, control limit, isolation forest and LOF—ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

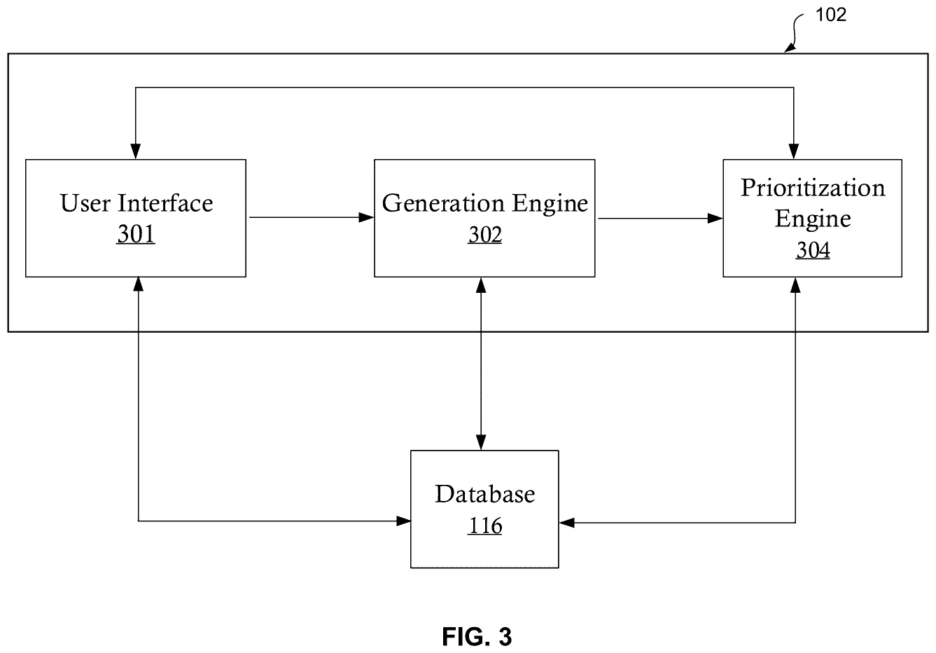

FIG. 3 is a flow diagram of recommendation engine 102, in accordance with some embodiments of the present teaching. As indicated in FIG. 3, recommendation engine 102 may include generation engine 302 and prioritization engine 304. Generation engine 302 may be configured to receive information from a user interface associated with a customer's device (e.g., user interface 301). In some embodiments, a customer utilizes user interface 301 to view and interact with one or more products and may select one product (e.g., anchor product) for further information or purchase. Interaction data may be transmitted from user interface 301 to generation engine 302. The interaction data may include interactions of the customer on a website or e-commerce platform. In some embodiments, the interaction data includes an anchor item. The anchor item may be a product that the customer is interacting with, viewing, or has added to their cart. In some embodiments, user interface 301 transmits the interaction data to database 116 for storage. The interaction data may be associated with a customer ID of the customer such that the customer is linked and associated with the interaction data pertaining to their interactions on the website. The interaction data may include customer historical data. Generation engine 302 may receive the interaction data from user interface 301 and/or database 116 and may identify an anchor item.

In some embodiments, generation engine 302 is configured to generate a plurality of recommended products. The plurality of recommended products may be products of various product types. The plurality of recommended products may be associated with the anchor item. In some embodiments, the plurality of recommended products generated by generation engine 302 are related to the anchor product or item such that the plurality of recommended products and the anchor product are cohesive. The plurality of recommended products and the anchor product being cohesive may indicate that the plurality of recommended products and the anchor product match together or form a cohesive look. For example, the plurality of recommended products may match the anchor product or may form a cohesive look with the anchor product.

The plurality of recommended products may include a first product, a second product, a third product, and a fourth product, each from a different product type. For example, the anchor item may be a white dress shirt and the plurality of recommend products may include a navy pants shirt (legwear product type), a pair of shoes (shoe product type), a watch (jewelry product type), and a jacket/blazer (outerwear product type). In some embodiments, generation engine 302 generates a plurality of recommended products that are each in a different product type compared to one another. Generation engine 302 may be configured to store data associated with the plurality of recommended products (e.g., generation data) within database 116. The generation data may be configured to assist in training, re-training, and/or refining the one or more models used by recommendation engine 102.

In some embodiments, generation engine 302 is configured to isolate of a subset from the plurality of recommended products. For example, the plurality of recommended products may include a large number of products of various product types and generation engine 302 may be configured to isolate a subset of the large number. The subset may include recommended products from each of the various product types. In some embodiments, generation engine 302 is configured to assign weights to each of the plurality of recommended products based on indicators associated with each of the plurality of recommended products. The indicators may include data associated with season of the product, popularity of the product, number of times the product has been purchased, number of times the product has been viewed, etc. Generation engine 302 may assign weights based on the indicators such as the products that are more popular (e.g., purchased most often) will have a higher weight than non-popular products. Generation engine 302 may rank the plurality of recommended products by weight in each product type and isolate a predetermined number of products for transmission to prioritization engine 304. For example, generation engine 302 may isolate a predetermined number of recommended products for each product type to generate a subset of recommended products and may transmit the subset to prioritization engine 304.

Generation engine 302 may be configured to transmit the generation data to prioritization engine 304. Prioritization engine 304 may be configured to receive historical transaction data associated with the customer. In some embodiments, prioritization engine 304 receives from database 116 historical transaction data associated with the customer. The historical transaction data may include demographical data associated with the customer, such as age, gender, location, marital status, child status, occupation, etc. In some embodiments, the historical transaction data includes data associated with previous interactions and transactions of the customer. For example, the historical transaction data may include previous purchased products, previous viewed products, previous interacted with products, billing history, delivery history, etc. Prioritization engine 304 may be configured to utilize one or more models to determine affinities of the customer form the historical transaction data. In some embodiments, prioritization engine 304 prioritizes the plurality of recommended products from the generation data based on the historical transaction history. For example, prioritization engine 304 may identify one or more products in each product type within the generation data that the customer has an affinity for based on the historical transaction data. In some embodiments, prioritization engine 304 prioritizes recommended products within each product type. Prioritization engine 304 may be configured to prioritize recommended products between product types. In some embodiments, prioritization engine 304 transmits the prioritization of the plurality of recommended products to user interface 301 for display to the customer.

In practice, a customer interacts with an anchor item using user interface 301. The anchor item may be transmitted to generation engine 302, which is configured to generate generation data including a plurality of recommended products based on the anchor item. The plurality of recommend products may include products within different product types. Each of the plurality of recommend products may visually match or have a cohesive look with the anchor item. Generation engine 302 may transmit the generation data to prioritization engine 304, which is configured to prioritize the plurality of recommend products. Prioritization engine 304 may, for example, identify one recommended product per product type for display to the customer. For example, prioritization engine 304 may assign weights to each of the plurality of recommended products within each product type and may present to the customer the highest weighted recommended product per product type. Prioritization engine 304 may transmit the highest weighted recommended product per product type (e.g., selected products) to user interface 301 for display to the customer. The customer may interact with the selected products provided by prioritization engine 304. In some embodiments, the selected products are determined by prioritization engine 304 as being products that are visually cohesive with the anchor item and are most likely to be purchased by the customer.

In some embodiments, user interface 301 receives interaction data that the customer has selected one or more selected products for purchase and transmits that interaction data to database 116. The interaction data may be used by recommendation engine 102 to train, re-train, and/or refine one or more models used by recommendation engine 102. In some embodiments, user interfaces 301 and 506 are the same. For example, user interface 301 and 506 may be the user interface of the same electronic device. User interface 301, 506, and 205 may be the same user interface or associated with the same device.

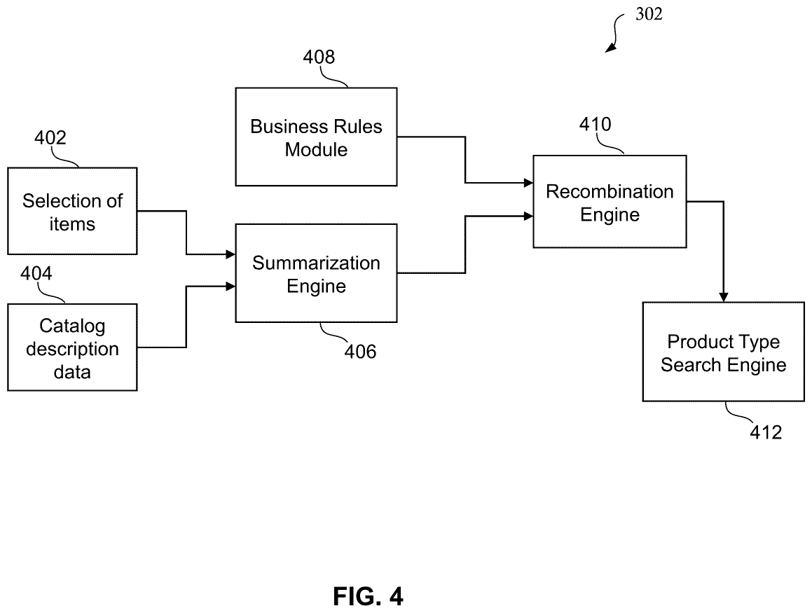

FIG. 4 illustrates flow diagram of generation engine 302. Generation engine 302 may include summarization engine 406, recombination engine 410, and product type search engine (“search engine”) 412. Summarization engine 406 may be configured to generate a summary of the anchor item received by generation engine 302 from user interface 301. Summarization engine 406 may receive selection of items 402 and catalog description 404. Selection of items 402 and catalog description 404 may be data stored within database 116 and retrieved by summarization engine 406. Selection of items 402 may include selection of anchor item by the customer. For example, the customer may access website of a retailer hosted on an e-commerce platform. The customer may interact with and view one or more products offered by the retailer. The customer may select one product (e.g., via click) and that product is assigned an anchor indicator designated that product as the anchor product or anchor item. The selection of the anchor product by the customer may be transmitted to summarization engine 406. In some embodiments, user interface 301 transmits the anchor product to summarization engine 406. In alternative embodiments, summarization engine 406 may receive the anchor product from database 116, which received the anchor product within interaction data from user interface 301.

Summarization engine 406 may receive catalog description data 404. In some embodiments, catalog description data 404 is stored within database 116 and is transmitted to summarization engine 406. For example, summarization engine 406 may request catalog description data 404 from database 116. Catalog description data 404 may include lengthy product descriptions and attributes of a plurality of products offered by the retailer, including product descriptions and attributes of the anchor product. For example, a retailer may have a catalog including a lengthy description of every product that the retailer offers. Catalog description data 404 may be at least a subset or portion of the catalog. For example, catalog description data 404 may include description data that includes anchor description data associated with the anchor product. In some embodiments, summarization engine 406 receives catalog description data 404 that only includes description data associated with the anchor product (e.g., anchor description data).

Catalog description data 404 may include description of one or more products, each description may include attributes of the product such as the size, material, shape, assembly instructions, location offered. In some embodiments, the description includes lengthy descriptions offered by the manufacturer or other individuals with knowledge of the product. The description may be in natural language. For example, the description may include text that describes the overall look and quality of the product, describes where or how the product can be used, components of the product, manufacturer information, contact information, assistance information, cleaning/maintenance information, potential buyers information, features, contents, accessories, attachments, instructions, manuals, etc. In some embodiments, each description is a lengthy narrative describing various aspects of the product. Narrative format may include descriptions that tell a story regarding the product and/or include complete and full sentences describing the product. Catalog description data 404 may be extremely lengthy and may include over 200 words for each product description. Catalog description data 404 may include over 25, 50, 100, 200, 300, 400, 500, or 1000 words for each description of each product offered by the retailer.

Summarization engine 406 may receive catalog description data 404 that includes anchor description data associated with the anchor product. In some embodiments, summarization engine 406 transmits a request for catalog description data 404 associated with the anchor product and receives anchor description data associated with the anchor product. In alternative embodiments, summarization engine 406 receives catalog description data 404 associated with a plurality of products, including the anchor product, and summarization engine 406 parses and extracts from catalog description data 404 the anchor description data that pertains to the anchor product.

In some embodiments, summarization engine 406 is configured to parse and extract a summary of the anchor product from catalog description data 404. In some embodiments, summarization engine 406 receives an anchor indicator associated with the anchor product and parses catalog description data 404 for the anchor indicator. The anchor indicator may be associated with the anchor product and summarization engine 406 may map the anchor indicator to catalog description data 404 to retrieve the anchor description data. The anchor description data may be a lengthy text narrative describing the anchor product. Summarization engine 406 may be configured to summarize anchor description data to generate anchor summary data. In some embodiments, anchor summary data is a subset of anchor description data. Anchor summary data may include substantially less text data compared to anchor description data. In some embodiments, anchor summary data is in text format.

Summarization engine 406 may utilize one or more models to generate anchor summary data from anchor description data. For example, summarization engine 406 may utilize a generative AI algorithm (e.g., Large Language Model (LLM)) to generate anchor summary data from anchor description data. Anchor summary data may be a text summary of anchor item identifying features of the anchor product. For example, anchor summary data may include text describing the name, style, components, dimensions, materials, and/or other differentiating attributes or features. In some embodiments, summarization engine 406 is configured to reduce the amount of text data (e.g., text) of anchor description data to generate anchor summary data. For example, anchor summary data may include less text data than anchor description data. In some embodiments, anchor summary data includes minimal text data, such as the least amount of text required to convey a description of the anchor product. In some embodiments, anchor summary data is less than 50 words. Anchor summary data may be less than 100 words, 25 words, 20 words, or fifteen words. In some embodiments, for each anchor product, anchor summary data is less than at least 50% of anchor description data.

In some embodiments, summarization engine 406 transmits anchor summary data associated with the anchor product to recombination engine 410. Recombination engine 410 may also receive one or more rules (e.g., business rules or product rules) from business rules module 408. Business rules module 408 may be coupled to database 116 and may store a plurality of rules within database 116. Business rules module 408 may retrieve one or more rules of the plurality of rules from database 116 and transmit the one or more rules to recombination engine 410. In some embodiments, business rules module 408 provides a plurality of rules that are associated with the anchor product. For example, the plurality of rules may be associated with the anchor product based on a product indicator. In some embodiments, each rule may include one or more product indicator to indicate which products that rule is applied to. The anchor product may include a product indicator as metadata or the product indicator may be attached as metadata to the anchor summary data. Business rules module 408 may receive the product indicator from database 116 and may transmit one or more rules associated with the product indicator to recombination engine 410.

The one or more rules may include rules associated with providing recommended products that have the same cohesive look as the anchor product. The rules provided by business rules module 408 may be a text data format. For example, the rules may be in text form and may be in a narrative format. The rules may include a plurality of if-then statements. In some embodiments, the rules include product types to avoid or recommend. The rules may include colors, materials, sizes, shapes, products, components, or styles to avoid or recommend. In some embodiments, the rules provided by business rules module 408 include one or more product types that the recommended product should be. For example, the rules may determine which product types are recommended to the customer.

In some embodiments, the one or more rules are fashion rules or design rules. The one or more rules may be related to interior design or fashion to allow for color matching and providing a cohesive look. The one or more rules may also include trends such as fashion trends or design trends to allow recombination engine 410 to generate descriptions of products that are popular or seasonal based on current trends. Business rules module 408 may generate rules based on input from one or more sources. For example, business rules module 408 may query third party databases to identify current trends and popular products and may generate rules based on the query. Business rules module 408 may receive rules from one or more individuals. For example, a fashion blogger or fashion designer may input one or more rules into business rules module 408.

Recombination engine 410 may receive anchor summary data associated with the anchor product selected by the customer from summarization engine 406 and one or more rules associated with the product from business rules module 408. In some embodiments, recombination engine 410 is configured to generate one or more recommended product description data. The recommended product description data includes data describing one or more recommended products. The recommended product description data may include text data (e.g., text) that provides descriptions, such as keywords, for one or more recommended products based on the anchor summary data and the rules. For example, based on the anchor summary data received from summarization engine 406 and the rules received from business rules module 408, recombination engine 410 may generate description data associated with one or more recommended products. The one or more recommended products may be related to the anchor product and provide a cohesive look with the anchor product.

The recommended product descriptions (e.g., recommended product description data) may include minimal text and may not be in narrative format. For example, the recommended product descriptions may include only the necessary text data (e.g., text) to convey information regarding the product type, color, style, and material of one or more recommended products. The recommended product descriptions may provide keywords for query of a search engine to identify one or more recommended products. The one or more recommended products may be products that are associated with the anchor product and provide a cohesive or similar look when used in conjunction with or near the anchor product. In some embodiments, recombination engine 410 generates recommended product description data of a different product types. For example, recombination engine 410 may generate recommended product description data of at least two different product types.

In some embodiments, each of summarization engine 406 and recombination engine 410 utilizes one or more models or algorithms. For example, each of summarization engine 406 and recombination engine 410 may utilize a generative AI algorithm, such as LLM, to generate data describing one or more products (e.g., anchor product or one or more recommended products).

Recombination engine 410 may transmit the generated recommended product description data to product type search engine (“search engine”) 412. Search engine 412 may be configured to search or query a catalog of products offered by the retailer. In some embodiments, the catalog being queried by search engine 412 is the same catalog that provided catalog description data 404. Search engine 412 may query the catalog based on the recommended product description data to identify a plurality of recommended products. The plurality of recommended products may be a plurality of products of different product types. The catalog may be stored within database 116 and search engine 412 may be configured to query database 116.

In some embodiments, recombination engine 410 generates recommended product description data with metadata include product type indicators indicating the product type associated with the recommended product description. Recombination engine 410 may transmit the recommended product description data with the product type indicators to search engine 412. Search engine 412 may search a catalog associated with the retailer using the recommended product description data and may search the catalog by product type based on the product type indicators. Search engine 412 may identify a plurality of recommended products of different product types from the catalog based on the recommended product description data received from recombination engine 410. The plurality of recommended products may include a plurality of products from different product types and may be associated with the anchor product. For example, the plurality of recommended products may provide a cohesive visual look or appearance with the anchor product. By way of an example, if the anchor product is an orange shirt, the plurality of recommended products may include blue jeans, white shoes, and a white watch, each product matching and providing a cohesive look with the anchor product.

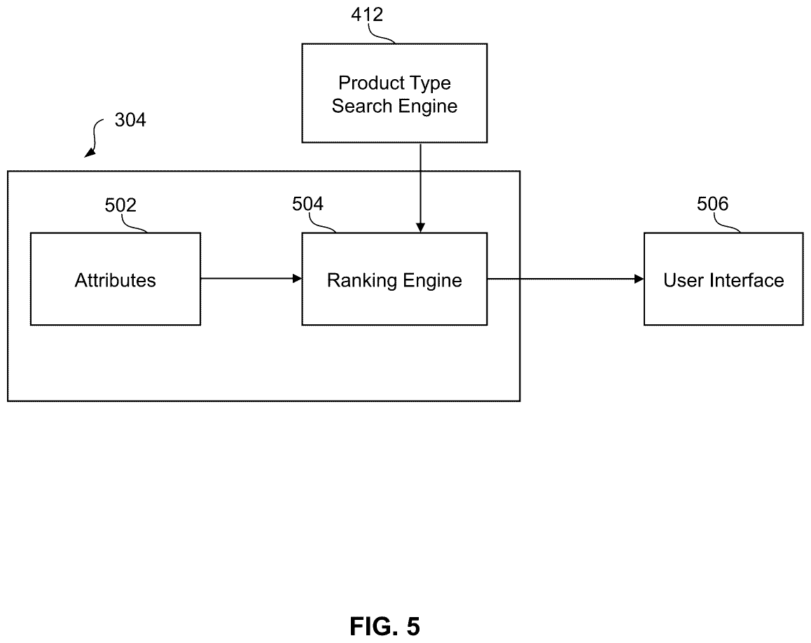

FIG. 5 illustrates flow diagram of prioritization engine 304. Recommendation engine 102 may include prioritization engine 304, which may be in communication with generation engine 302. In some embodiments, search engine 412 may transmit the plurality of recommended products identify from a catalog of a retailer to prioritization engine 304. Prioritization engine 304 may include ranking engine 504. Ranking engine 504 may be configured to receive attributes 502. Attributes 502 may be stored within database 116. In some embodiments, attributes 502 includes historical customer data.

The historical customer data may be associated with a specific customer. In some embodiments, recommendation engine 102 is configured to tag the historical customer data with a customer identifier associated with the customer. Recommendation engine 102 may be configured to map the customer identifier to the historical customer data to link the historical customer data to the customer. In some embodiments, historical customer data includes customer demographics, customer profiles, transactions of customers, purchase history, delivery history, billing history, viewing history, browsing features, and customer interactions with an e-commerce platform of the retailer. Ranking engine 504 may be configured to receive historical customer data associated with a customer and determine affinities of the customer. For example, based on prior transactions of the customer, ranking engine 504 may identify a brand affinity, color affinity, size affinity, etc. In some embodiments, ranking engine 504 is configured to identify one or more products interacted with by the customer based on the historical customer data. Ranking engine 504 may generate affinities of the customer based on attributes 502. The affinities of the customer may indicate preferences of the customer that would result in a high likelihood of the customer purchasing a specific product. For example, based on attributes 502, ranking engine 504 may determine that the customer associated with the anchor product has an affinity for the color blue indicating that the customer has a higher likelihood of purchasing a product it has a blue color.

Ranking engine 504 may receive the plurality of recommended products from generation engine 302 (e.g., via search engine 412) and may receive attributes 502. Ranking engine 504 may be configured to apply weights to each of the plurality of recommended products based on affinities of the customer. Using the above example, ranking engine 504 may apply a higher weight to products that have the color blue compared to products that do not have the color blue. In some embodiments, the higher the weight applied, the higher likelihood that the customer would purchase the product based on the affinities determined by ranking engine 504. In some embodiments, weights have a value from 0 to 1.

In some embodiments, a customer may utilize an e-commerce platform to add one or more products to an initial basket. Recommendation engine 102 may analyze the historical customer data associated with the customer and may identify affinities associated with the customer. Recommendation engine 102 may use one or more models to identify affinities associated with the customer.

In some embodiments, ranking engine 504 prioritizes the plurality of recommended products by the applied weights within each product type. For example, a higher weight may be given a higher priority or higher ranking by ranking engine 504. In some embodiments, ranking engine 504 is configured to aggregate and group the plurality of recommended products based on product type. Ranking engine 504 may be configured to prioritize the recommended products within each product type to identify one or more high priority products to present to the customer. In some embodiments, ranking engine 504 presents one product per product type to the customer, the one product having the highest prioritization (e.g., highest weight). Ranking engine 504 may present one product, two products, three products, four products, five products, or greater than five products per product type. In some embodiments, ranking engine 504 presents less than ten product types. For example, ranking engine 504 may present less than ten product types, each having the highest weighted recommended product resulting in ranking engine 504 presenting less than ten recommended products of different product types. Ranking engine 504 may present less than five, less than seven, less fifteen, or less than twenty product types.

Ranking engine 504 may generate a plurality of priority products. The plurality of priority products may be the top weighted product within each presented product type, the top weighted product being selected from the plurality of recommended products received from search engine 412. Ranking engine 504 may cause user interface 506 to display the plurality of priority products. In some embodiments, the plurality of priority products includes one product each from a plurality of product types. For example, the plurality of priority products may include a first product from a first product type, a second product from a second product type, and a third product from a third product type, where the first product type, the second product type, and the third product type are each a different product type.

FIG. 5 illustrates an exemplary user interface 506. Ranking engine 504 may generate a plurality of priority products and cause user interface 506 to display the plurality of priority products. In some embodiments, the plurality of priority products may be generated and displayed in response to a customer selecting or interacting with an anchor item (e.g., anchor item 601). For example, a customer may interact with anchor item 601 by clicking it or adding to a cart for purchase. Upon interacting with anchor item 601, recommendation engine 102 may generate a plurality of recommended products and prioritize the plurality of recommended products to generate a plurality of priority products for display by user interface 506. The plurality of recommended products may be prioritized to generate the plurality of priority products based on the customer's affinities.

User interface 506 may display the plurality of priority products (e.g., elements 602, 604, 606, 608, 610, 612). In some embodiments, user interface 506 may display elements 602, 604, 606, 608, 610, 612 in close proximity to anchor item 601. In some embodiments, each of elements 602, 604, 606, 608, 610, 612 is a different product type. For example, element 602 may be a first product type, element 604 may be a second product type, element 606 may be a third product type, element 608 may be a fourth product type, element 610 may be a fifth product type, and element 612 may be a sixth product type.

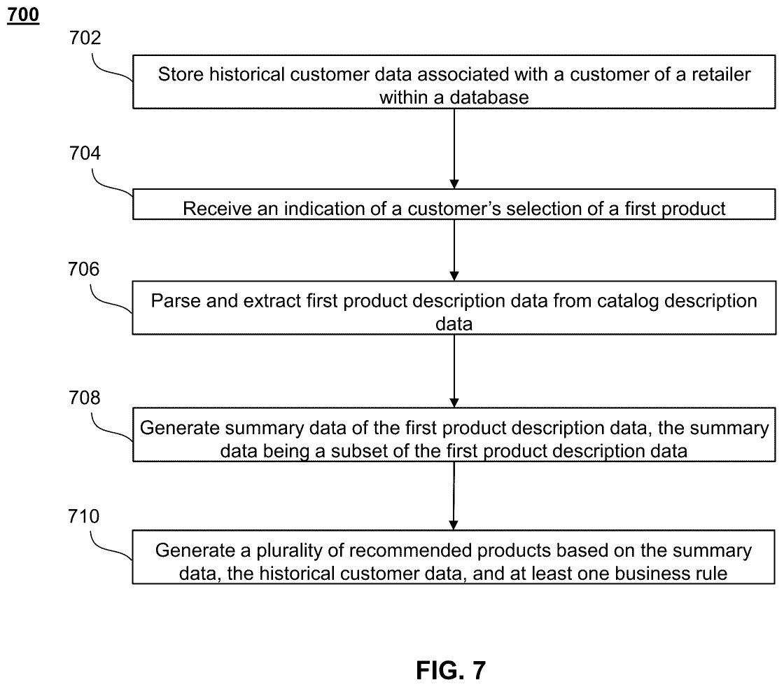

FIG. 7 is a flowchart illustrating an exemplary method for generating cohesive product recommendations. At operation 702, recommendation engine 102 stores historical customer data within database 116. Recommendation engine 102 may receive historical customer data from an electronic device or user interface associated with the customer. The historical customer data may include interaction data associated with the customer's interaction with an e-commerce platform of a retailer. At operation 704, recommendation engine 102 may receive an indication of a customer's selection of a first product (e.g., an anchor product). The customer may be selecting the first product to add to a cart for purchase or may be viewing additional information about the first product. Upon selection of the first product, recommendation engine 102 may be configured to parse catalog description data 404 for information pertaining to the first product. Recommendation engine 102 may identify anchor description data based on parsing of catalog description data 404. At operation 708, using one or more models, such as a generative AI algorithm or large language model, recommendation engine 102 may generate summary data based on the anchor description data. The summary data may be a subset of the anchor description data. In some embodiments, the summary data is reduced text data compared to the anchor description data.

At operation 710, recommendation engine 102 may generate a plurality of recommended products based on the summary data. For example, recommendation engine 102 may query a catalog of a retailer based on the summary data and one or more rules, such as fashion or design rules, to generate a plurality of recommended products. The plurality of recommended products may include one or more products in a different product groups. The plurality of recommended products may be products that are visually cohesive with the first product (e.g., the anchor product). For example, each of the plurality of recommended products may be visually cohesive with the first product such that each of the plurality of recommended products matches or

In some embodiments, recommendation engine 102 groups the plurality of products by product type and applies weights to the plurality of recommended products within each product type. The weights may be applied based on a customer's affinities determined by the historical customer data. The affinities may to various attributes of products such as shape, color, size, material, style, etc. Recommendation engine 102 may prioritize or rank the plurality of recommended products within each product type to generate a plurality of priority products. The plurality of priority products are the recommended product in each product type with the highest weight. The recommended product in each product type with the highest weight indicates the product that the customer has a high likelihood of purchasing. Recommendation engine 102 may display using a user interface the plurality of priority products. For example, recommendation engine 102 may cause a user interface to display the plurality of priority products, each being a different product type.

In some embodiments, the plurality of priority products is displayed on the user interface proximate the first product (e.g., anchor product). For example, upon selection of the first product, recommendation engine 102 may generate and display the plurality of priority products to the customer for interacting with.

In some embodiments, one or more filtering and/or review processes may be implemented at various stages to identify and/or prevent generation of undesirable image content. For example, one or more filtering processes may be applied to identify, remove, and/or otherwise eliminate undesirable content such as inappropriate images, offensive images, restricted images, etc. Filtering may occur at any suitable stage of an image generation process, such as, for example, one or more of operation or step 702, 704, 706, 710, etc. Although specific embodiments are discussed herein, it will be appreciated that any suitable filtering may applied at any suitable steps of the disclosed methods.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
obtain historical customer data associated with a customer,
receive an indication of the customer's selection of a first product,
parse and extract first product description data of the first product from catalog description data,
generate summary data of the first product description data, the summary data being a subset of the first product description data, and
generate a plurality of recommended products based on the summary data, the historical customer data, and at least one business rule.

2. The system of claim 1, wherein the instructions, when executed, further cause the processor to:
generate recommended product description data associated with the plurality of recommended products;
query a catalog based on the recommended product description data; and
based on the query, generate the plurality of recommended products.

3. The system of claim 1, wherein the instructions, when executed, further cause the processor to:
group the plurality of recommended products by product types;
apply one or more weights to each of the plurality of recommended products within each product type, the one or more weights being applied based on the historical customer data; and
prioritize, within each product type, the plurality of recommended products based on the applied one or more weights.

4. The system of claim 1, wherein the instructions, when executed, further cause the processor to:
cause a user interface to display a visual representation of the plurality of recommended products, the visual representation of the plurality of recommend products being displayed proximate a visual representation of the first product.

5. The system of claim 1, wherein the summary data is generated using a generative artificial intelligence model.

6. The system of claim 1, wherein the summary data is generated using a large language model.

7. The system of claim 1, wherein each of the plurality of recommended products is visually cohesive with the first product.

8. The system of claim 1, wherein the historical customer data includes interaction data associated with the customer's interactions with one or more retail products provided on an e-commerce platform.

9. The system of claim 1, wherein each of the plurality of recommended products has a different product type, respectively.

10. The system of claim 1, wherein the first product has a different product type than each of the plurality of recommended products.

11. A method comprising:
obtaining historical customer data associated with a customer;
receiving an indication of the customer's selection of a first product;
parsing and extracting first product description data of the first product from catalog description data;
generating summary data of the first product description data, the summary data being a subset of the first product description data; and
generating a plurality of recommended products based on the summary data, the historical customer data, and at least one business rule.

12. The method of claim 11, further comprising:
generating recommended product description data associated with the plurality of recommended products;
querying a catalog based on the recommended product description data; and
based on the query, generating the plurality of recommended products.

13. The method of claim 11, further comprising:
grouping the plurality of recommended products by product types;
applying one or more weights to each of the plurality of recommended products within each product type, the one or more weights being applied based on the historical customer data; and
prioritizing, within each product type, the plurality of recommended products based on the applied one or more weights.

14. The method of claim 11, further comprising:
causing a user interface to display a visual representation of the plurality of recommended products, the visual representation of the plurality of recommend products being displayed proximate a visual representation of the first product.

15. The method of claim 11, wherein the summary data is generated using at least one of: a generative artificial intelligence model or a large language model.

16. The method of claim 11, wherein each of the plurality of recommended products is visually cohesive with the first product.

17. The method of claim 11, wherein the historical customer data includes interaction data associated with the customer's interactions with one or more retail products provided on an e-commerce platform.

18. The method of claim 11, wherein the first product has a different product type than each of the plurality of recommended products.

19. A non-transitory computer readable medium having instructions stored thereon, wherein the instructions, when executed by at least one processor, cause at least one device to perform operations comprising:
obtaining historical customer data associated with a customer;
receiving an indication of the customer's selection of a first product;
parsing and extracting first product description data of the first product from catalog description data;
generating summary data of the first product description data, the summary data being a subset of the first product description data; and
generating a plurality of recommended products based on the summary data, the historical customer data, and at least one business rule.

20. The non-transitory computer readable medium of claim 19, wherein the operations further comprise:
generating recommended product description data associated with the plurality of recommended products;
querying a catalog based on the recommended product description data; and
based on the query, generating the plurality of recommended products.
